(19) United States
(12) Patent Application Publication
(10) Pub. No.: US 2025/0333632 A1
(43) Pub. Date: Oct. 30, 2025

(54) HEAT TRANSFER FLUIDS BASED ON SYNTHETIC ESTERS WITH HIGH THERMAL CONDUCTIVITY

(71) Applicant: VGP IPCO LLC, Lexington, KY (US)

(72) Inventors: Keshav Sopan Badhe, Mumbai (IN); Sulaksha Parab, Goa (IN); Rajkumar Rajule, Kalyan West (IN); Gefei Wu, Lexington, KY (US); Ning Ren, Naperville, IL (US); Roger England, Lexington, KY (US); Ying Yang, Lexington, KY (US)

(21) Appl. No.: 18/646,857

(22) Filed: Apr. 26, 2024

(51) Int. Cl. C09K 5/10

(52) U.S. Cl. CPC C09K 5/10

(57) ABSTRACT

Heat transfer fluids were formulated with a neat solution of a synthetic ester base stock. A base stock prepared with a neat ester according to the invention has similar performance characteristics to commercially available heat transfer fluids.

### TECHNICAL FIELD

This disclosure relates to heat transfer fluids primarily composed of an ester base stock. Also, this disclosure relates to a method for conducting heat transfer in a heating and/or cooling system using a heat transfer fluid having an ester base stock.

### BACKGROUND

Transfer of heat from local high temperature zones is a critical performance feature of lubricants and circulating fluids. Specialized fluids are used for the sole purpose of removing heat from high temperature zones, e.g. coolants in internal combustion engines. Currently, there is a need to cool the battery and power generation systems in electric or hybrid vehicles using fluids aimed for heat removal. Traditional fluids remove heat via combination of conductivity and convection mechanisms and the heat removed is a function of fluid properties such as heat capacity, thermal conductivity, density and viscosity. Improving heat transfer is an emerging need as energy density of systems and equipment increases.

The use of dielectric fluids in electrical apparatus is well known which provides electrical insulation, cooling and prevent excessive temperature rise, and thus prolong the lifetime of equipment. Dielectric fluids known for such use include paraffinic base fluids, mineral oil based fluids, natural ester based fluids and synthetic ester based fluids. Known synthetic esters include those produced from the reaction of an alcohol with one or more carboxylic acids. Dielectric fluids based on such synthetic esters have a number of advantages over paraffinic base fluids, mineral oil based fluids, but there remains a need for synthetic esters having improved properties.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

In some aspects, a heat transfer fluid comprising a neat ester stock or ester stock blend as a base fluid and an additive is described in detail.

Other methods, features and/or advantages is, or will become, apparent upon examination of the following FIGURES and detailed description. It is intended that all such additional methods, features, and advantages be included within this description and are protected by the accompanying claims.

### BRIEF DESCRIPTION OF DRAWINGS

FIG. 1 is a table of synthetic esters of the invention.

### DETAILED DESCRIPTION

### I. Definitions

Unless otherwise defined, all technical and scientific terms used herein have the same meaning as commonly understood by one of ordinary skill in the art to which this invention pertains. In case of conflict, the present specification, including definitions, will control.

Unless otherwise specified, “a,” “an,” “the,” “one or more of,” and “at least one” are used interchangeably. The singular forms “a”, “an,” and “the” are inclusive of their plural forms.

The recitations of numerical ranges by endpoints include all numbers subsumed within that range (e.g., 0.5 to 5 includes 1, 1.5, 2, 2.75, 3, 3.80, 4, 5, etc.).

The term “about,” when referring to a value or to an amount of mass, weight, time, volume, concentration, or percentage is meant to encompass variations of +10% from the specified amount. The terms “comprising” and “including” are intended to be equivalent and open-ended. The phrase “consisting essentially of” means that the composition or method may include additional ingredients and/or steps, but only if the additional ingredients and/or steps do not materially alter the basic and novel characteristics of the claimed composition or method. The phrase “selected from the group consisting of” is meant to include mixtures of the listed group.

Moreover, the present disclosure also contemplates that in some aspects, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Weight percent: All weight (and mass) percents expressed herein (unless otherwise indicated) are based on overall composition weight.

### II. Ester Base Stock

According to some aspects of the invention, heat transfer fluids were formulated with a neat solution of a synthetic ester base stock or ester stock blend. A base stock prepared with a neat ester stock or ester stock blend according to the invention has similar performance characteristics to commercially available heat transfer fluids.

### III. Additives

In some aspects, the neat ester fluid will be formulated with an additive that may include antioxidant, agents, extreme pressure agents, dispersants, detergents, antioxidants, anti-wear agents, viscosity modifiers, pour point depressants, friction modifiers, corrosion inhibitors, anti-foaming agents, demulsifiers, or seal swell agents are used in amounts generally encountered in the art, for example between about 0.01 wt % and about 20 wt %, or between 1 wt % and about 20 wt %. In some formulations, the amount of total additive does not exceed 20 wt %. In some formulations, the amount of total additive does not exceed 10 wt %. In some formulations, the amount of total additive is between about 5 wt % and about 10 wt %. In some formulations, the amount of total additive if between 5 wt % and 10 wt %. In The lubricant may also contain a wt % of additive of any single number or 6.4 wt %.

In some aspects, the additive may comprise an ester. However, the term “neat” ester in this context refers to the base stock that is a formulation comprising between about 80 wt % to 99.9 wt % of a neat ester solution.

Viscosity modifiers are also called as viscosity index improver or viscosity improvers. This may be included in the formulation. Viscosity index improver include reaction product of amines for example polyamines, with a hydrocarbyl substituent mono or dicarboxylic acid in which hydrocarbyl substituent comprises a chain of sufficient length to impart viscosity index improving properties to the compounds. In general, the viscosity improver may be polymer of a C4 to C24 unsaturated ester of unsaturated alcohol or C3 to C10 unsaturated monocarboxylic acid or a C4 to C10 dicarboxylic acid with an unsaturated nitrogen containing monomer having 4 to 20 carbon atoms, a polymer of C2 to C20 olefin with an unsaturated C3 to C10 mono or dicarboxylic acid neutralized with an amine, hydroxyl amine or an alcohol; or a polymer of ethylene with a C3 to C20 olefin further reacted either by grafting a C4 to C20 unsaturated nitrogen containing monomer or by grafting with an unsaturated acid on to the polymer backbone and then reacting carboxylic group of the grafted acid with amine, hydroxylamine or alcohol. Formulation may also include multifunctional viscosity modifier which may have both dispersant and antioxidant properties.

The compositions may contain a viscosity modifier or a combination of viscosity modifiers. The viscosity improvers used in the lubricant industry can be used in the instant invention for the oil medium, which include olefin copolymers (OCP), polymethacrylates (PMA), hydrogenated styrene-diene (STD), and styrene-polyester (STPE) polymers. Olefin copolymers are rubber-like materials prepared from ethylene and propylene mixtures through vanadium-based Ziegler-Natta catalysis. Styrene-diene polymers are produced by anionic polymerization of styrene and butadiene or isoprene. Polymethacrylates are produced by free radical polymerization of alkyl methacrylates. Styrene-polyester polymers are prepared by first co-polymerizing styrene and maleic anhydride and then esterifying the intermediate using a mixture of alcohols.

Other compounds which can be used in the instant invention in the oil medium include: acrylic polymers such as polyacrylic acid and sodium polyacrylate, high-molecular-weight polymers of ethylene oxide such as Polyox WSR from Union Carbide, cellulose compounds such as carboxymethylcellulose, polyvinyl alcohol (PVA), polyvinyl pyrrolidone (PVP), xanthan gums and guar gums, polysaccharides, alkanolamides, amine salts of polyamide, hydrophobically modified ethylene oxide urethane, silicates, and fillers such as mica, silicas, cellulose, wood flour, clays (including organoclays) and clays, and resin polymers such as polyvinyl butyral resins, polyurethane resins, acrylic resins and epoxy resins.

A viscosity modifier may be present in the final formulation in an amount from about 0.1 wt % to about 10 wt % on a pure rubber basis. In some aspects a viscosity modifier is selected so as to provide the final formulation rubber in an amount between about 0.1 wt % and 2 wt %. The amount of rubber in the final formulation may be between about 0.1 wt % and about 1 wt % or any number within that range, e.g. 0.7 wt %.

Pour point depressant are used to allow the lubricant formulation to operate at lower temperature. Typical additives which improves the fluidity of lubricant formulation are C8 to C18 dialkyl fumarate/vinyl acetate copolymer and polymethacrylates.

In addition, any defoamer or antifoamer that may be present in the additive package, at least one additional antifoamer may be added to the composition. At least two antifoamers are added to the heat transfer fluid. More than two antifoamers may also be added to the heat transfer fluid. The heat transfer fluid may include an anti-foaming agent that is an organic acid ester, a siloxane, a silicone based fluid or a combination of any of these compounds. One antifoamer, may include a mixture of compounds such as an organic acid ester and siloxane, such as, for example, the commercially available Nalco® 2301. One antifoamer may be silicone based, such as for example the commercially available Chemaloy F-655.

The final composition may include the anti-foaming agent in an amount greater than about 0.01 (w/w) % and less than about 0.5 (w/w) %. The anti-foaming agent maybe present in an amount of about 0.1 (w/w) %. The anti-foaming agent may be described by any single digit found in the range between about 0.01 (w/w) % and less than about 0.5 (w/w) %, such as 0.1 wt %. The anti-foaming agent may be a mixture of organic acid ester and siloxane or a silicone based fluid. The heat transfer fluid may contain one, two or more than two anti-foaming agents. The antifoaming agent may comprise any appropriate defoamer.

The heat transfer fluids may also include additives in the form of an additive package. The performance additive package is generally a fully formulated composition, including antioxidant agents, antiwear agents, extreme pressure agents, detergents, dispersants, antifoamer, anti-rust agents, friction modifiers, corrosion inhibitors, and pour point depressants. The performance additive package may be commercially available, such as DI package, and used as directed by manufacturer. Additives such as a colorant or dye may also be added to the heat transfer fluid.

Dispersants commonly used in the automotive industry contain a lipophilic hydrocarbon group and a polar functional hydrophilic group. The polar functional group can be of the class of carboxylate, ester, amine, amide, imine, imide, hydroxyl, ether, epoxide, phosphorus, ester carboxyl, anhydride, or nitrile. The lipophilic group can be oligomeric or polymeric in nature, usually from 70 to 200 carbon atoms to ensure good oil solubility. Hydrocarbon polymers treated with various reagents to introduce polar functions include products prepared by treating polyolefins such as polyisobutene first with maleic anhydride, or phosphorus sulfide or chloride, or by thermal treatment, and then with reagents such as polyamine, amine, ethylene oxide, etc. A surfactant or a mixture of surfactants with low HLB value (typically less than or equal to 8), preferably nonionic, or a mixture of nonionics and ionics, may be used as a dispersant.

Other chemical compounds, preferably polymers, not for the purpose of dispersing, but to achieve thickening or other desired fluid characteristics. These can be added but reduce the amount of particulate that can be used without excessive thickening.

Chemical compounds such as seal swell agents or plasticizers can also be used in the instant invention and may be selected from the group including phthalate, adipate, sebacate esters, and more particularly: glyceryl tri (acetoxystearate), epoxidized soybean oil, epoxidized linseed oil, n-butyl benzene sulfonamide, aliphatic polyurethane, epoxidized soy oil, polyester glutarate, polyester glutarate, triethylene glycol caprate/caprylate, long chain alkyl ether, dialkyl diester glutarate, monomeric, polymer, and epoxy plasticizers, polyester based on adipic acid, hydrogenated dimer acid, distilled dimer acid, polymerized fatty acid trimer, ethyl ester of hydrolyzed collagen, isostearic acid and sorbian oleate and cocoyl hydrolyzed keratin, PPG-12/PEG-65 lanolin oil, dialkyl adipate, alkylaryl phosphate, alkyl diaryl phosphate, modified triaryl phosphate, triaryl phosphate, butyl benzyl phthalate, octyl benzyl phthalate. alkyl benzyl phthalate, dibutoxy ethoxy ethyl adipate, 2-ethylhexyldiphenyl phosphate, dibutoxy ethoxy ethyl formyl, diisopropyl adipate, diisopropyl sebacate, isodecyl oieate, neopentyl glycol dicaprate, neopenty giycol diotanoate, isohexyl neopentanoate, ethoxylated lanolins, polyoxyethylene cholesterol, propoxylated (2 moles) lanolin alcohols, propoxylated lanoline alcohols, acetylated polyoxyethylene derivatives of lanoline, and dimethylpolysiloxane. Other plasticizers which may be substituted for and/or used with the above plasticizers including glycerine, polyethylene glycol, dibutyl phthalate, and 2,2,4-trimethyl-1,3-pentanediol monoisobutyrate, and diisononyl phthalate all of which are soluble in a solvent carrier. Other seal swelling agents such as LUBRIZOL 730 can also be used.

The additives may be added individually or as an additive package.

In some aspects the additive package may be in the form of a concentrate that is diluted to supply the final formulation.

In one aspect, the invention is a heat transfer fluid comprising as a neat ester stock or ester stock blend any of Ex 1 through Ex 15 as the stock in an amount between 80 wt % and 99.9 wt % and the additive is present in an amount between 0.1 wt % and 20 wt %.

In some aspects, the additive present with the neat ester stock or ester stock blend is an additive that is an antioxidant agent, an extreme pressure agent, a dispersant, a detergent, an anti-wear agent, a viscosity modifier, a pour point depressant, a friction modifier, a corrosion inhibitor, an anti-foaming agent, a demulsifier, a seal swell agent, or a combination thereof.

In some aspects, the ester stock blend is a combination of Ex 1 and Ex 9. In some aspects this heat transfer fluid has: a Brookfield viscosity @−30° C. of about 9000 to about 10,000 and/or a kinematic viscosity @ 100° C. of about 5.0 to about 6.5. In some aspects this heat transfer fluid has: a Brookfield viscosity @−30° C. of about 9400 or a kinematic viscosity @ 100° C. of about 5.5.

### EXAMPLES

For the purposes of promoting an understanding of the principles of the present disclosure, reference will now be made to preferred aspects and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

### Example 1: Heat Transfer Fluids with the Following Structures Having a Free Hydroxyl Groups were Synthesized and their Thermal Properties were Studied

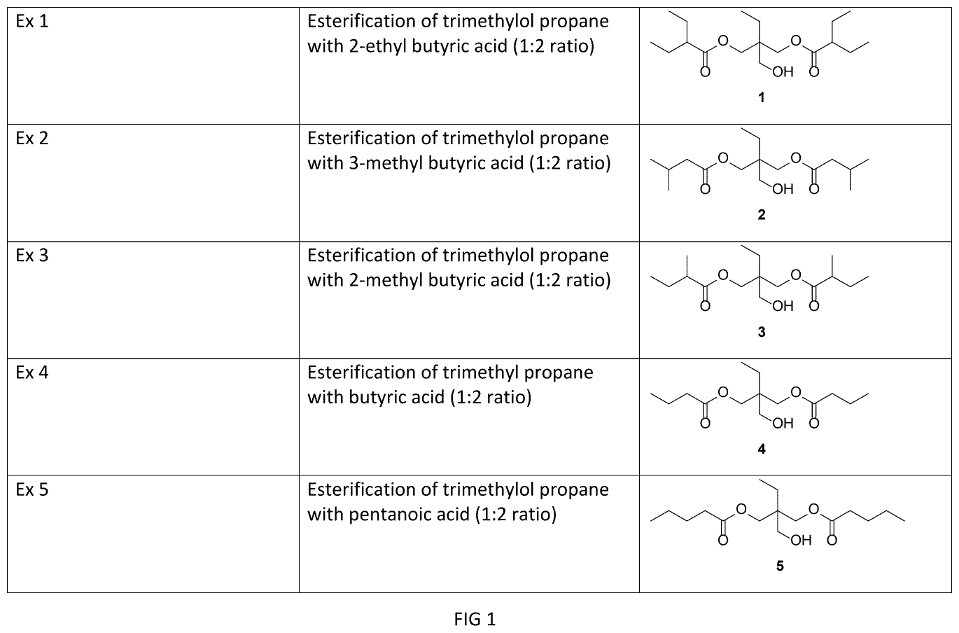

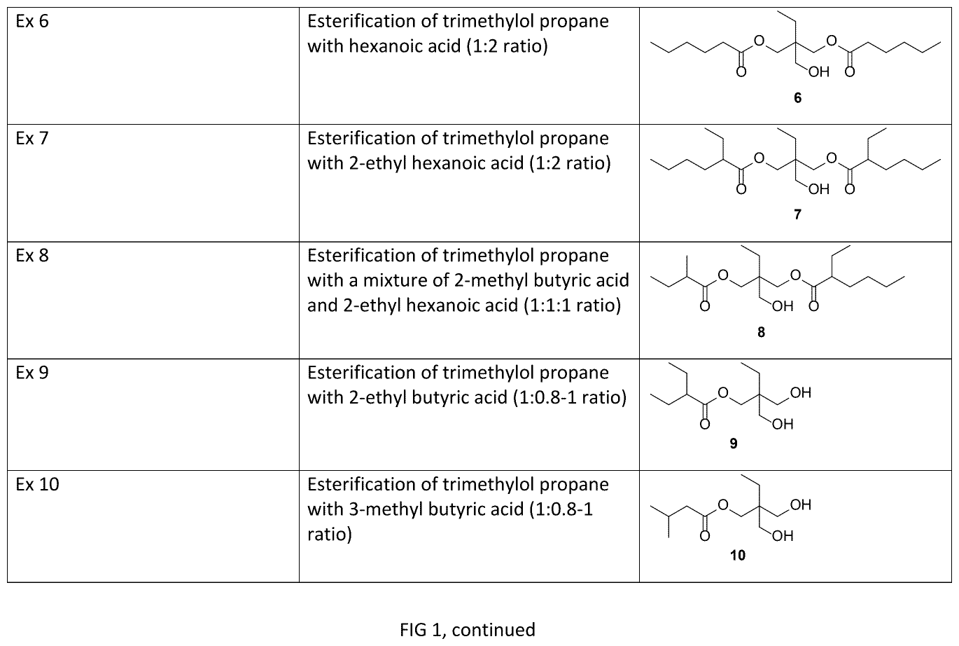

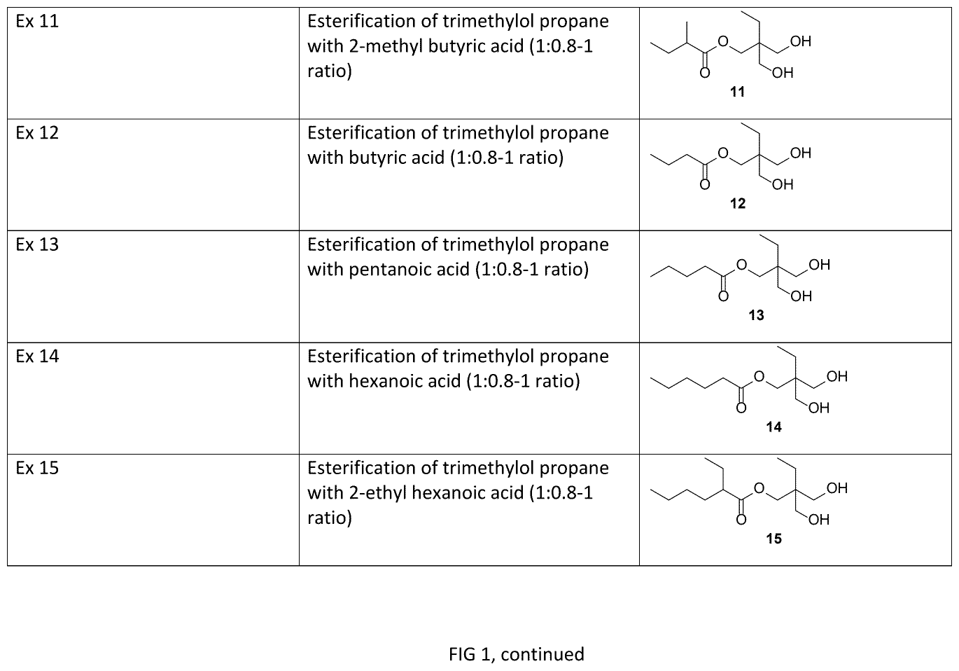

The monoesters and diesters were synthesized by esterification of the triols with the corresponding monoacids (butyric acid, pentanoic acid, hexanoic acid, 2-methylbutyric acid, 3-methylbutyric acid, 2-ethylbutyric acid, 2-ethylhexanoic acid) with the following structures, wherein R and R1 may be same or different. The ester stocks are assigned and Example No, Ex, numbered Ex 1 through Ex 15 as summarized below and in FIG. 1.

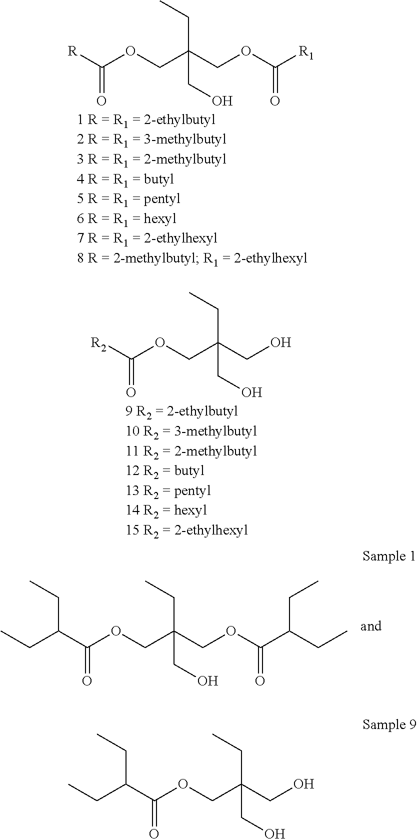

Tests on the esters: Thermal conductivity being the most critical parameter, it was recorded on the individual esters.

Sample 1, with a single free hydroxyl group, recorded the highest thermal conductivity, so far. To further enhance the thermal conductivity, sample 9 with two free hydroxyl groups was combined with sample 1 in 1:1 ratio (Sample 16). Sample 16 showed the highest thermal conductivity, probably due to the interaction of the free hydroxyl groups in the molecules.

TABLE 1
Thermal conductivity of esters

| Sample # | Thermal conductivity, Wm/K |
|---|---|
| 1 | 0.1448 |
| 9 | 0.122 |
| 16 | 0.152 |

TABLE 2
Preliminary test on sample 16

| | | | | | Thermal |
|---|---|---|---|---|---|
| Kv@40° | Kv@100° | BF@−30° | Cp @ 28° | Pour point | conductivity, |
| C. | C. | C. | C. | ° C. | Wm/K |
| 59.75 | 5.46 | 9380 | 1.761 | −60 | 0.152 |

### EXPERIMENTAL

Ex 1 to Ex 7: Trimethylol propane (1 mols) and the corresponding acid (2 mols) in Toluene (50 mL) were heated to 140 C with p-toluene sulfonic acid (PTSA) as a catalyst (0.1 mole) for 8-12 h, as indicated by TLC, with azeotropic removal of water.

Ex 8 (unsymmetrical diester): Trimethylol propane (1 mols), the corresponding acid-1 (1 mols) and the corresponding acid-2 (1 mols) in Toluene (50 mL) were heated to 140 C with p-toluene sulfonic acid (PTSA) as a catalyst (0.1 mole) for 8-12 h, as indicated by TLC, with azeotropic removal of water.

Ex 9 to Ex 15: Trimethylol propane (1 mols) and the corresponding acid (0.8 to 1 mols) in Toluene (50 mL) were heated to 140 C with p-toluene sulfonic acid (PTSA) as a catalyst (0.1 mole) for 8-12 h, as indicated by TLC, with azeotropic removal of water.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. A heat transfer fluid comprising the compound: 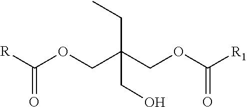
wherein
1 R=R₁=2-ethylbutyl
2 R=R₁=3-methylbutyl
3 R=R₁=2-methylbutyl
4 R=R₁=butyl
5 R=R₁=pentyl
6 R=R₁=hexyl
7 R=R₁=2-ethylhexyl
8 R=2-methylbutyl; R₁=2-ethylhexyl
or the compound 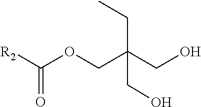
wherein
9 R₂=2-ethylbutyl
10 R₂=3-methylbutyl
11 R₂=2-methylbutyl
12 R₂=butyl
13 R₂=pentyl
14 R₂=hexyl
15 R₂=2-ethylhexyl

2. The heat transfer fluid of claim 1, wherein the neat ester stock or ester stock blend is present in an amount between 80 wt % and 99.9 wt % and the additive is present in an amount between 0.1 wt % and 20 wt %.

3. The heat transfer fluid of claim 1, wherein the additive is an antioxidant agent, an extreme pressure agent, a dispersant, a detergent, an anti-wear agent, a viscosity modifier, a pour point depressant, a friction modifier, a corrosion inhibitor, an anti-foaming agent, a demulsifier, a seal swell agent, or a combination thereof.

4. A heat transfer fluid comprising an ester stock that is a blend of any of Ex 1 through Ex 15.

5. A heat transfer fluid comprising an ester stock as a base fluid and an additive, wherein the ester stock is a blend of Ex 1 and Ex 9.

6. The heat transfer fluid of claim 5, wherein the neat ester stock is present in an amount between 80 wt % and 99.9 wt % and the additive is present in an amount between 0.1 wt % and 20 wt %.

7. The heat transfer fluid of claim 5, wherein the additive is an antioxidant agent, an extreme pressure agent, a dispersant, a detergent, an anti-wear agent, a viscosity modifier, a pour point depressant, a friction modifier, a corrosion inhibitor, an anti-foaming agent, a demulsifier, a seal swell agent, or a combination thereof.

8. The heat transfer fluid of claim 5, wherein the heat transfer fluid has:
a Brookfield viscosity @−30° C. of about 9400 or a kinematic viscosity @ 100° C. of about 5.5.
